(19) United States
(12) Patent Application Publication
(10) Pub. No.: US 2006/0264217 A1
(43) Pub. Date: Nov. 23, 2006

(54) Method and system for reporting evolved utran capabilities

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/432,781

(22) Filed: May 11, 2006

Related U.S. Application Data
(60) Provisional application No. 60/682,634, filed on May 19, 2005.

(51) Int. Cl. H04Q 7/20

(52) U.S. Cl. 455/445; 370/218; 370/352

(57) ABSTRACT

A method and system for reporting evolved universal mobile telecommunication systems (UMTS) terrestrial radio access network (E-UTRAN) capabilities are disclosed. A wireless transmit/receive unit (WTRU) sends a first message to a core network (CN) to report the E-UTRAN capabilities of the WTRU. The CN then updates the WTRU capabilities based on the first message. The first message may include a radio access capability information element (IE) which carries information related to E-UTRAN capabilities of the WTRU and/or a network capability IE which carries information regarding network capabilities of the WTRU. The CN may send a second message to the WTRU to report network capabilities with respect to the radio access networks (RANs) to which the core network is connected and services that can be provided over the E-UTRAN.

### CROSS REFERENCE TO RELATED APPLICATION

This application claims the benefit of U.S. provisional application No. 60/682,634 filed May 19, 2005, which is incorporated by reference as if fully set forth.

### FIELD OF INVENTION

The present invention is related to a wireless communication system. More particularly, the present invention is related to a method and system for reporting evolved universal mobile telecommunication systems (UMTS) terrestrial radio access network (E-UTRAN) capabilities.

### BACKGROUND

Different types of wireless access systems have been developed to provide different types of services. Some examples of the wireless access systems include wireless local area networks (WLANs), (such as IEEE 802-based networks), and cellular networks, (such as UMTS terrestrial radio access network (UTRAN), a global packet radio service (GPRS)/enhanced data rate for global system for mobile communication (GSM) evolution (EDGE) radio access network (GERAN), or the like). Each of these networks have been developed and tailored to provide specific applications.

Proposals for an E-UTRAN have been made to improve wireless system capacity and enhanced performance. The E-UTRAN will provide significant advantages over existing wireless communication systems and additional services may be available through the E-UTRAN. FIG. 1 shows an exemplary integrated wireless communication system 100 including the E-UTRAN. The system 100 includes an access system stratum 110, a network stratum 120 and a multimedia stratum 130. The access system stratum 110 includes a plurality of RANs, a core network (CN) 116 and an evolved CN 117. The RANs include a generic access network (GAN) 111, a GERAN 112, a UTRAN 113, an E-UTRAN 114 and an interworking wireless local area network (I-WLAN) 115. The RANs 111-115 are connected to the CN 116 or the evolved CN 117 to provide services, (such as multimedia services from an Internet protocol (IP) multimedia subsystem (IMS) 131), to one or more WTRUs while interacting with an authentication, authorization and accounting (AAA) server 121, a mobile IP (MIP) server 122, or other network entities in the network stratum 120 via a gateway GPRS support node (GGSN) 118 or a packet data gateway (PDG) 119.

Currently, multimode WTRUs for supporting several wireless communication systems are available. The capabilities of each of the WTRUs may vary. For example, some WTRUs may support only UMTS, while other WTRUs may have an I-WLAN support. The WTRUs that are capable of supporting E-UTRAN will also be available in the future. When the WTRU has an E-UTRAN support, it would be desirable to report the WTRU capabilities to a CN and to report additional E-UTRAN services to the WTRUs such that the WTRUs may receive and/or utilize such additional services.

### SUMMARY

The present invention is related to a method and system for reporting E-UTRAN capabilities. The WTRU sends a first message to report the E-UTRAN capabilities of the WTRU to a CN. The CN then updates the WTRU capabilities based on the first message. The first message may include a radio access capability information element (IE) which carries information regarding the E-UTRAN capabilities of the WTRU and/or a network capability IE which carries information regarding network capabilities of the WTRU. The CN may send a second message to the WTRU to report network capabilities with respect to the radio access networks (RANs) to which the core network is connected and services that can be provided over the E-UTRAN.

### BRIEF DESCRIPTION OF THE DRAWINGS

FIG. 1 shows an exemplary prior art integrated wireless communication system including an E-UTRAN and an evolved CN.

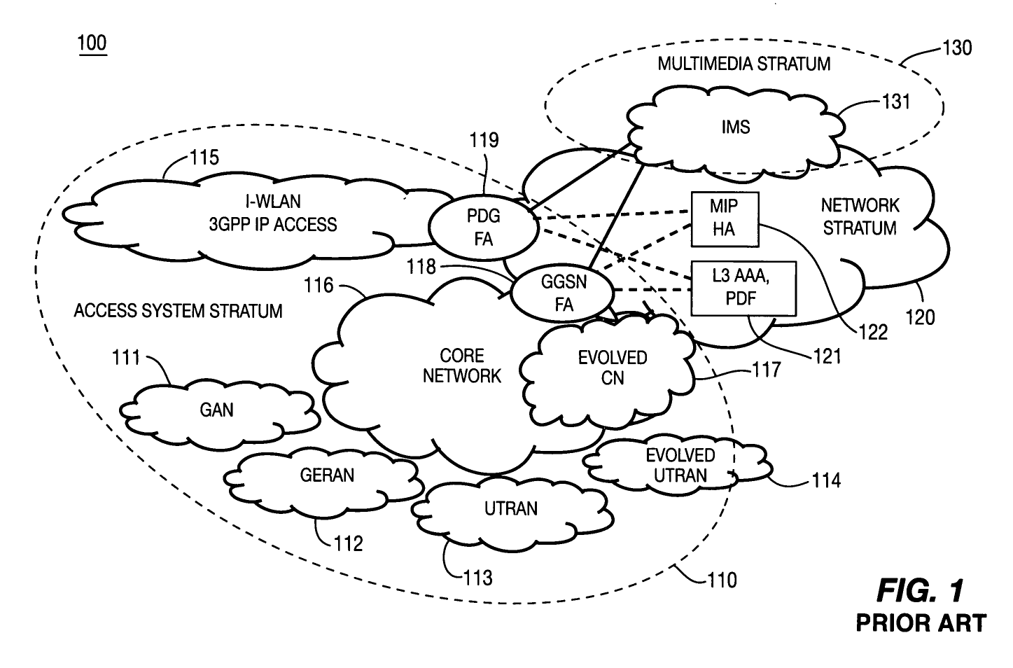

FIG. 2 is a block diagram of an exemplary integrated wireless communication system configured in accordance with the present invention.

FIG. 3 is a flow diagram of a process for reporting E-UTRAN capabilities of a multimode WTRU in accordance with the present invention.

FIGS. 4A and 4B are diagrams of network capability IEs in accordance with prior art and the present invention.

FIGS. 5A and 5B are diagrams of radio access capability IEs in accordance with the prior art and the present invention.

### DETAILED DESCRIPTION OF THE PREFERRED EMBODIMENTS

When referred to hereafter, the terminology “WTRU” includes but is not limited to a user equipment, a mobile station, a fixed or mobile subscriber unit, a pager, or any other type of device capable of operating in a wireless environment.

The features of the present invention may be incorporated into an integrated circuit (IC) or be configured in a circuit comprising a multitude of interconnecting components.

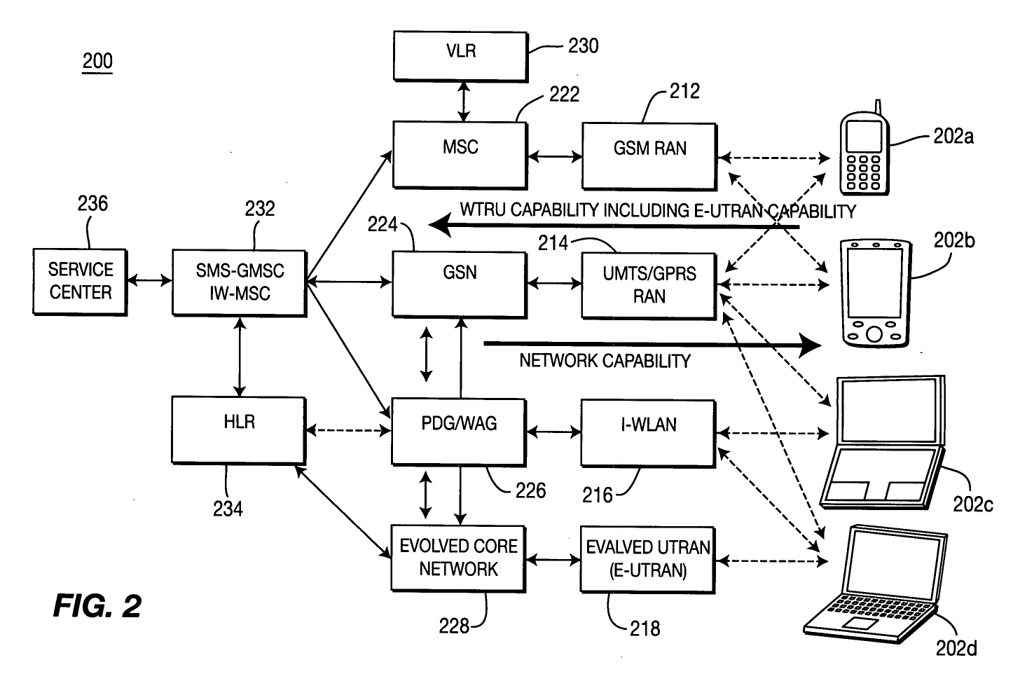

FIG. 2 is a block diagram of an exemplary integrated wireless communication system 200 configured in accordance with the present invention. In FIG. 2, many different types of WTRUs 202a-202d having different capabilities are communicating with the integrated system 200 including many different types of RANs 212, 214, 216 and 218. For example, a cellular phone 202a and a personal data assistance (PDA) 202b are shown communicating with a global standards for mobile communication (GSM) RAN 212 and a UMTS/GPRS RAN 214, and a laptop computer 202c is shown communicating with the UMTS/GPRS RAN 214 and an I-WLAN 216. Another laptop computer 202d is shown communicating with the UMTS/GPRS 214, an I-WLAN 216 and an E-UTRAN 218. All WTRUs 202a-202d have a capability to communicate with the UMTS/GPRS RAN 214. As mentioned above, the system 200 of FIG. 2 is presented as an example. Thus, different types of WTRUs having different capabilities and different types and compositions of RANs are possible.

Each of the RANs 212-218 is connected to a CN entity. For example, the GSM RAN 212 is connected to a mobile switching center (MSC) 222 to handle calls under GSM radio access technology (RAT). The UMTS/GPRS RAN 214 is connected to a GPRS support node (GSN) 224 for supporting UMTS and GPRS services. The I-WLAN 216 is connected to a PDG and/or a WLAN access gateway (WAG) 226 for supporting WLAN services. The E-UTRAN 218 is connected to the evolved CN 228 for supporting E-UTRAN services. The CN entities 222-228 are further connected to other network entities, such as a visitor location register (VLR) 230, a home location register (HLR) 234 and a short message service (SMS)-gateway mobile switching center (GMSC)/interworking mobile switching center (IW-MSC) 232 for providing a service, such as SMS, from a service center 236. The SMS-GMSC/IW-MSC 232 serves as a gateway between the service center 236 and the MSC 222, the GSN 224 or the PDG/WAG 226. The SMS-GMSC/IW-MSC 232 accepts mobile terminated or originated messages and delivers the messages to and from the MSC 222, the GSN 224 or the PDG/WAG 226.

In accordance with the present invention, a WTRU 202a-202d reports WTRU capabilities including E-UTRAN capabilities to the CN over the UMTS/GPRS RAN 214. After the CN is aware of the capabilities of the WTRU 202a-202d, the CN may report network capabilities, such as interworking capabilities and other types of services, (e.g., services that are available to WTRUs having E-UTRAN capabilities), to the WTRU 202a-202d over the UMTS/GPRS RAN 214.

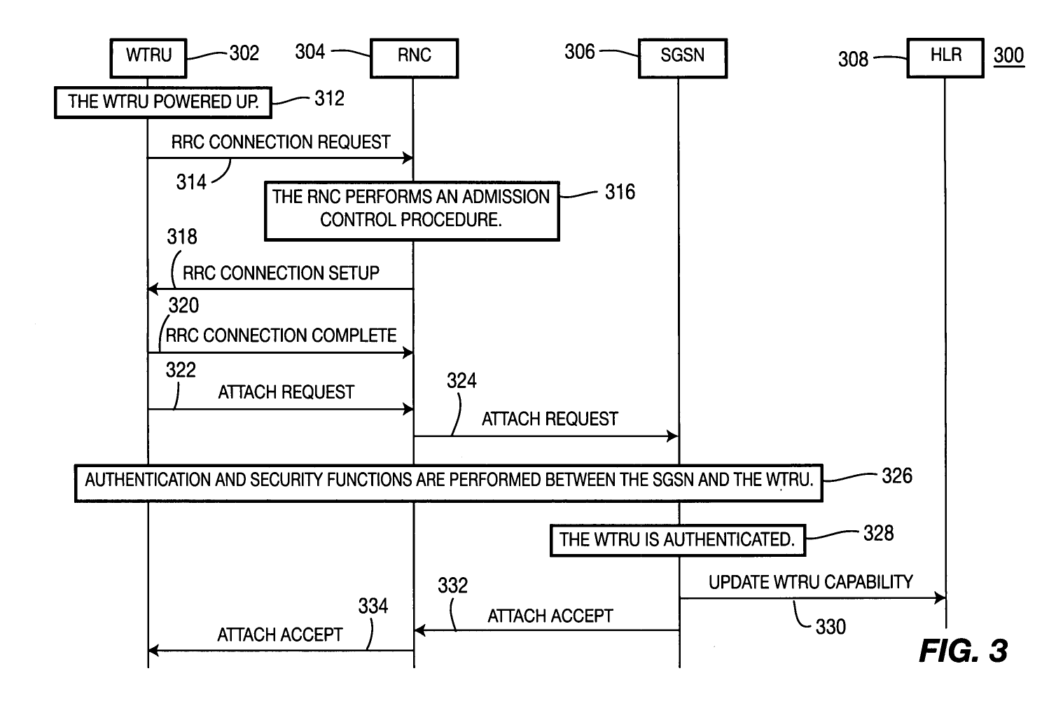

FIG. 3 is a flow diagram of a process 300 for reporting E-UTRAN capabilities of a multimode WTRU 302 in accordance with the present invention. The WTRU 302 includes multiple radio units for supporting multiple wireless communication interfaces, such as an E-UTRAN air interface, an UTRAN air interface, an I-WLAN air interface, a GPRS/GSM air interface, or the like. Preferably, the WTRU 302 informs a CN about its E-UTRAN capability during an attachment procedure to the UMTS system, (i.e., registration).

Upon power up at step 312, the WTRU 302 sends a radio resource control (RRC) connection request message to a radio network controller (RNC) 304 of an UMTS/GPRS RAN to establish a connection to the UMTS/GPRS RAN (step 314). The RNC 304 performs an admission control procedure based on a plurality of factors, such as the availability of resources, or the like (step 316). If the RNC 304 decides to admit the WTRU 302, the RNC 304 sends an RRC connection setup message to the WTRU 302 (step 318). The WTRU 302 then sends an RRC connection complete message to the RNC 304 (step 320).

The WTRU 302 then sends an attach request message to the RNC 304 in order to receive GPRS services (step 322). In accordance with the present invention, the E-UTRAN capability information is sent along with the attach request message. The RNC 304 selects a serving GRPS support node (SGSN) 306 to serve the WTRU 302 and forwards the attach request message to the selected SGSN along with the E-UTRAN capability information (step 324). Authentication and security functions are then performed between the WTRU 302 and the SGSN 306 (step 326). Once the WTRU 302 is authenticated at step 328, the SGSN 306 sends an update WTRU capability message to an HLR 308 to update WTRU capabilities (step 330). The SGSN 306 then sends an attach accept message to the WTRU 302 via the RNC 304 (steps 332, 334). The SGSN 306 may include the message to report the network capabilities in the attach accept message.

In accordance with the present invention, a radio access capability IE and a network capability IE of existing GPRS/UMTS capability messages are amended to include new values to report the E-UTRAN capability information to a CN.

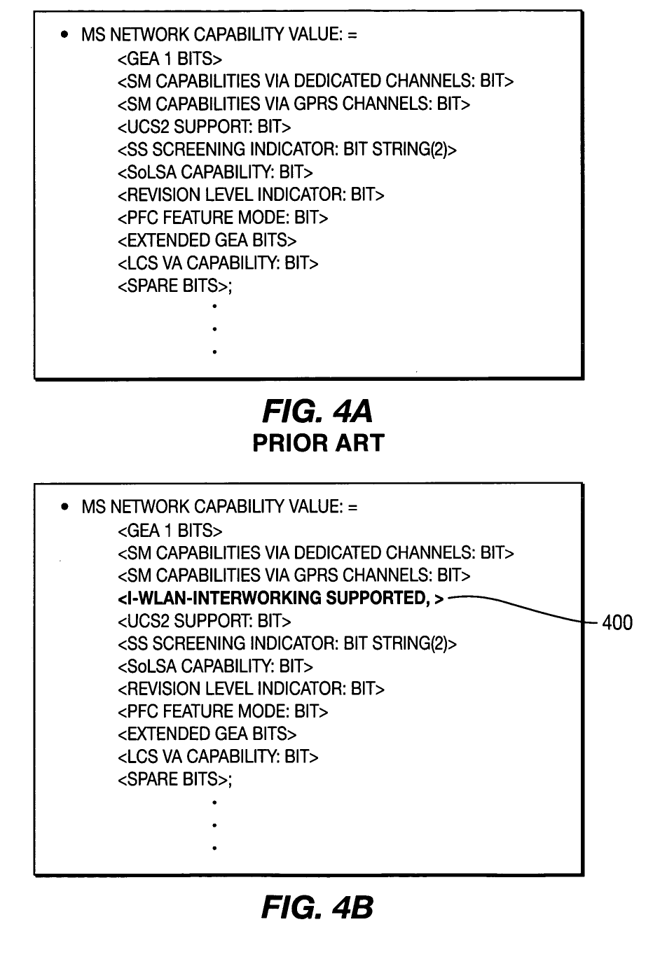

FIGS. 4A and 4B show the network capability IEs before and after being amended in accordance with the present invention. The network capability IEs report WTRU characteristics to the CN. As shown in FIG. 4B, the network capability IE includes a new value 400 to indicate the E-UTRAN capabilities, such as an I-WLAN interworking capability, of the WTRU in accordance with the present invention.

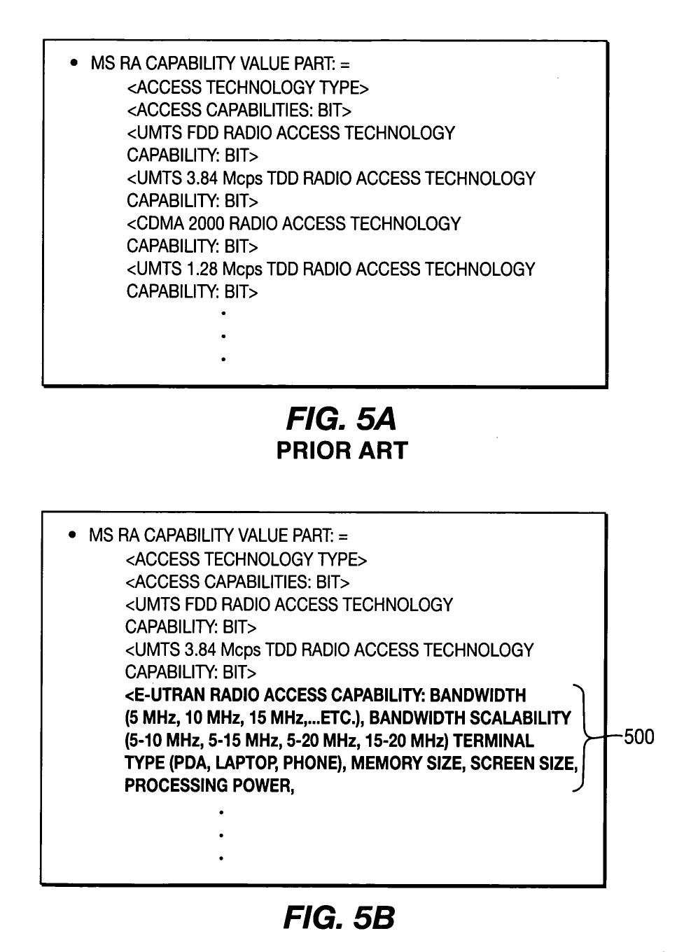

FIGS. 5A and 5B show the radio access capability IEs before and after being amended in accordance with the present invention. The radio access capability IEs report information concerning radio aspects of the WTRU to the CN. As shown in FIG. 5B, the radio access capability IE includes a new value 500 to report the multimode capabilities of the WTRU, (e.g., support of E-UTRAN and/or other technologies) to the CN. The new value 500 in the radio access capability IE carries all aspects of the E-UTRAN capabilities of the WTRU including supported technology, (e.g., orthogonal frequency division multiplexing (OFDM), orthogonal frequency division multiple access (OFDMA), wideband code division multiple access (WCDMA), or the like), supported bandwidth, (e.g., 5 MHz, 10 MHz, 15 MHz, 20 MHz, etc.), scalability, supported bit rates, quality of service (QoS) support, terminal type, (e.g., PDA, laptop, phone), memory size, screen size, processing power, or the like.

As described hereinbefore, after updating the WTRU capability, the CN may send a second message to the WTRU 302 to report the availability of new network capabilities, (such as I-WLAN capabilities and evolved CN capabilities), or services that can be provided over the E-UTRAN. The second message may by included in the attach accept message or any other message. The availability of new network capabilities may be indicated by using the same network capability IE shown in FIG. 4B.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method of reporting evolved universal mobile telecommunication systems (UMTS) terrestrial radio access network (E-UTRAN) capabilities, the method comprising:
a wireless transmit/receive unit (WTRU) sending a first message to a core network (CN), the first message reporting E-UTRAN capabilities of the WTRU to the CN; and
the CN updating the WTRU capabilities based on the first message.

2. The method of claim 1 wherein the first message includes a radio access capability information element (IE) which carries information related to the E-UTRAN capabilities of the WTRU.

3. The method of claim 2 wherein the radio access capability IE includes at least one of supported technology information, supported bandwidth information, scalability information, supported bit rates information, quality of service (QoS) information, terminal type information, memory size information, screen size information, and processing power information.

4. The method of claim 1 the WTRU supports at least one of an E-UTRAN air interface, a UTRAN air interface, an interworking wireless local area network (I-WLAN) air interface, and a global packet radio services (GPRS) and global standards for mobile communication (GSM) air interface.

5. The method of claim 1 wherein the first message includes a network capability information element (IE) which carries information related to network capabilities of the WTRU.

6. The method of claim 5 wherein the network capability IE includes information related to interworking capabilities with an interworking wireless local area network (I-WLAN).

7. The method of claim 1 wherein the first message is transmitted during an attach procedure.

8. The method of claim 1 further comprising:
the CN sending a second message to the WTRU, the second message reporting network capabilities with respect to a plurality of radio access networks (RANs) to which the CN is connected.

9. The method of claim 8 wherein the second message includes information regarding interworking capabilities with an interworking wireless local area network (I-WLAN).

10. The method of claim 8 wherein the second message includes information regarding services that can be provided over the E-UTRAN.

11. The method of claim 8 wherein the second message is transmitted during an attach procedure.

12. An integrated wireless communication system for reporting evolved universal mobile telecommunication systems (UMTS) terrestrial radio access network (E-UTRAN) capabilities, the system comprising:
a core network (CN); and
a wireless transmit/receive unit (WTRU) configured to send a first message to the CN, the first message reporting E-UTRAN capabilities of the WTRU to the CN, wherein the CN updates the WTRU capabilities based on the first message.

13. The system of claim 12 wherein the first message includes a radio access capability information element (IE) which carries information related to the E-UTRAN capabilities of the WTRU.

14. The system of claim 12 wherein the radio access capability IE includes at least one of supported technology information, supported bandwidth information, scalability information, supported bit rates information, quality of service (QoS) information, terminal type information, memory size information, screen size information, and processing power information.

15. The system of claim 12 wherein the CN is connected to a plurality of radio access networks (RANs) deployed under different radio access technologies including at least one of an E-UTRAN, a UMTS terrestrial radio access network (UTRAN), an interworking wireless local area network (I-WLAN), and a global packet radio services (GPRS) and global standards for mobile communication (GSM) network.

16. The system of claim 12 wherein the first message includes a network capability information element (IE) which carries network capabilities of the WTRU.

17. The system of claim 16 wherein the network capability IE includes information related to interworking capabilities with an interworking wireless local area network (I-WLAN).

18. The system of claim 12 wherein the first message is transmitted during an attach procedure.

19. The system of claim 15 wherein the CN is configured to send a second message to the WTRU, the second message reporting network capabilities with respect to the RANs to which the CN is connected.

20. The system of claim 19 wherein the RANs include an interworking wireless local area network (I-WLAN) and the second message includes information regarding interworking capabilities with the I-WLAN.

21. The system of claim 19 wherein the second message includes information regarding services that can be provided over the E-UTRAN.

22. The system of claim 19 wherein the second message is transmitted during an attach procedure.
